(19) United States
(12) Patent Application Publication
(10) Pub. No.: US 2025/0306753 A1
(43) Pub. Date: Oct. 2, 2025

(54) ELECTRONIC DEVICE AND CONTROL METHOD

(71) Applicant: Lenovo (Beijing) Limited, Beijing (CN)

(72) Inventors: Shijun YUAN, Beijing (CN); Liang ZHANG, Beijing (CN)

(21) Appl. No.: 19/087,489

(22) Filed: Mar. 22, 2025

(30) Foreign Application Priority Data
Mar. 31, 2024 (CN) 202410385071.1

(51) Int. Cl. G06F 3/04883; G06F 3/0484; H04M 1/72454

(52) U.S. Cl. CPC G06F 3/04883; G06F 3/0484; H04M 1/72454

(57) ABSTRACT

An electronic device includes a proximity sensor, a target screen including a display area that includes a collection area corresponding to the proximity sensor, and a processor configured to control, in response to a first trigger condition being satisfied, the proximity sensor to be in an enabled state, and control, in response to a second trigger condition being satisfied, a target interface to be displayed in the display area in a display mode, in which a target control in the target interface does not overlap with the collection area and does not overlap with a target area. The target area belongs to the display area and is related to a target edge of the collection area.

### CROSS-REFERENCE TO RELATED APPLICATION

This application claims priority to Chinese Patent Application No. 202410385071.1, filed on Mar. 31, 2024, the entire content of which is incorporated herein by reference.

### TECHNICAL FIELD

The present disclosure generally relates to the field of electronic device technologies and, more particularly, to an electronic device and a control method.

### BACKGROUND

An under-screen proximity sensor (P-Sensor) of an electronic device, such as a foldable phone, may be set at a position under a display screen that affects screen operation because of small display screen space and limitations in hardware layout. This may easily affect a user's operations on a display interface of the display screen (the display screen equipped with the under-screen proximity sensor), making it difficult for the user to operate the display interface of the display screen without impediment and affecting the user's usage experience.

### SUMMARY

In accordance with the disclosure, there is provided an electronic device including a proximity sensor, a target screen including a display area that includes a collection area corresponding to the proximity sensor, and a processor configured to control, in response to a first trigger condition being satisfied, the proximity sensor to be in an enabled state, and control, in response to a second trigger condition being satisfied, a target interface to be displayed in the display area in a display mode, in which a target control in the target interface does not overlap with the collection area and does not overlap with a target area. The target area belongs to the display area and is related to a target edge of the collection area.

Also in accordance with the disclosure, there is provided a control method including controlling, in response to a first trigger condition being satisfied, a proximity sensor to be in an enabled state. The proximity sensor corresponds to a collection area in a display area of a target screen of an electronic device. The method further includes controlling, in response to a second trigger condition being satisfied, a target interface to be displayed in a display mode, in which a target control in the target interface does not overlap with the collection area and does not overlap with a target area. The target area belongs to the display area and is related to a target edge of the collection area.

Also in accordance with the disclosure, there is provided a non-transitory computer-readable storage medium storing instructions that, when executed by a processor, cause the processor to control, in response to a first trigger condition being satisfied, a proximity sensor to be in an enabled state. The proximity sensor corresponds to a collection area in a display area of a target screen of an electronic device. The instructions, when executed by the processor, further cause the processor to control, in response to a second trigger condition being satisfied, a target interface to be displayed in a display mode, in which a target control in the target interface does not overlap with the collection area and does not overlap with a target area. The target area belongs to the display area and is related to a target edge of the collection area.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained according to these drawings without any creative work.

FIG. 1 is a schematic diagram showing an operation on a call interface displayed on an outer screen of a foldable mobile phone.

FIG. 2 is a schematic structural diagram of an electronic device consistent with the disclosure.

FIG. 3 is a schematic diagram showing a display area, a collection area, and related edges, consistent with the disclosure.

FIG. 4A and FIG. 4B are different schematic diagrams showing a target area consistent with the disclosure.

FIG. 5 is a schematic diagram showing a target interface displayed in a first display mode consistent with the disclosure.

FIG. 6 is a schematic diagram showing a user's finger needing to cross a collection area to operate a button X in a target area consistent with the disclosure.

FIG. 7A and FIG. 7B are schematic diagrams showing a foldable mobile phone at different viewing angles after being unfolded and relevant components thereof consistent with the disclosure.

FIG. 7C is a schematic diagram showing a foldable mobile phone after being folded consistent with the disclosure.

FIG. 7D is a schematic diagram showing a target screen of an electronic device in a folded state displaying interface content with a second display mode consistent with the disclosure.

FIG. 8 is a schematic diagram showing a target screen of an electronic device in a folded state displaying interface content with a first display mode consistent with the disclosure.

FIG. 9 is a schematic diagram showing controlling display of a first display interface in a second display mode and controlling display of a second display interface in a first display mode consistent with the disclosure.

FIG. 10A and FIG. 10B are schematic diagrams showing barrier-free operations on a display interface of a target screen consistent with the disclosure.

FIG. 11 is a flow chart of a control method consistent with the disclosure.

### DETAILED DESCRIPTION OF THE EMBODIMENTS

Embodiments of the present disclosure are described hereinafter with reference to the accompanying drawings. The described embodiments are only some of the embodiments of the present disclosure, and not all of the embodiments. Based on the embodiments in the present disclosure, all other embodiments obtained by those skilled in the art without creative work are within the scope of the present disclosure.

An under-screen proximity sensor (P-Sensor) of an electronic device such as a foldable phone may be set at a position under a display screen that affects screen operation because of small display screen space and limitations in hardware layout. This may easily affect a user's operations on a display interface of the display screen (the display screen which is equipped with the under-screen proximity sensor).

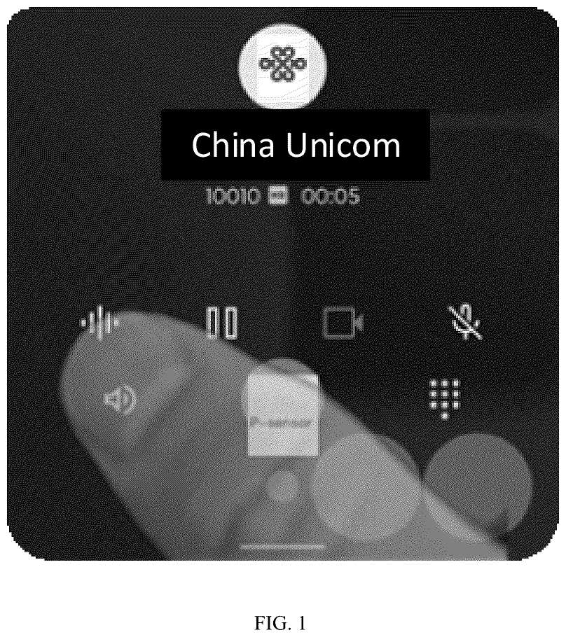

For example, as shown in FIG. 1, in a foldable mobile phone, an under-screen proximity sensor is provided at the bottom of an outer screen (specifically, below the bottom of the outer screen, that is, below the P-sensor area in FIG. 1, to form the under-screen proximity sensor), rather than at the top of the outer screen. When the foldable mobile phone is in a call scene and the user needs to operate a button on the call interface (such as a recording button, a number button, etc.), if the button overlaps (completely or partially) with a collection area of the proximity sensor such as the P-sensor area in FIG. 1, once the user extends a finger to perform the operation of clicking the button, the proximity sensor may detect the human body proximity event, causing the outer screen to be mistakenly turned off/locked, which will cause the user to be unable to operate the button on the call interface normally and make it difficult to ensure that the user is able to operate the display interface without obstacles, affecting the user's experience.

The present disclosure provides an electronic device and a control method, to at least partially alleviate the above problems and ensure that the user is able to operate the display interface of the display screen without obstacles while the electronic device is able to perform the required control based on the proximity behavior detection capability of the target object (such as the human body) using the proximity sensor to prevent accidental touching of the display screen. The electronic device may be, but is not limited to, a terminal device with information display and data processing capabilities, such as a foldable mobile phone or a non-foldable mobile phone.

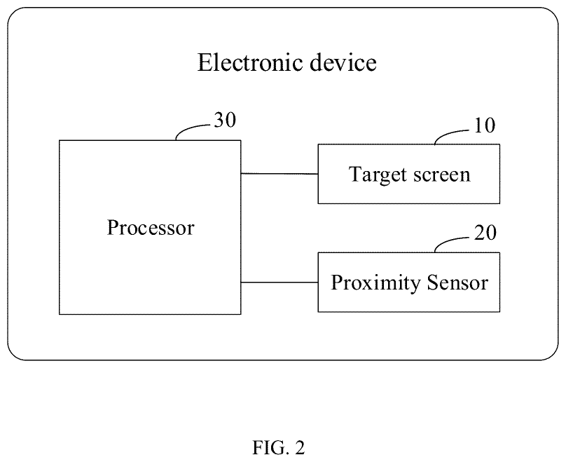

The present disclosure provides an electronic device. FIG. 2 is a schematic structural diagram of an electronic device consistent with the disclosure. As shown in FIG. 2, in one embodiment, the electronic device includes: a target screen 10, a proximity sensor 20, and a processor 30.

The target screen may include a display area for providing an information display function for the electronic device. The target screen 10 may be, but is not limited to, a display screen such as a flexible screen or an LCD screen or OLED screen

The proximity sensor may correspond to a collection area.

Optionally, the proximity sensor may be an under-screen proximity sensor disposed underneath the target screen, which may be, but is not limited to, a capacitive or inductive proximity sensor.

The collection area may be part of the display area of the target screen, and may be an area corresponding to the proximity sensor in the display area of the target screen for sensing the proximity behavior of a target object (such as a human body). For example, the collection area may be an area in the display area of the target screen that corresponds to a sensitive element, such as a conductive electrode plate, of the proximity sensor, used for sensing the proximity behavior of the target object such as the human body.

The processor may be used to control the proximity sensor to be in an enabled state based on the satisfaction of a first trigger condition; and to control a target interface to be displayed in the display area of the target screen in a first display mode based on the satisfaction of a second trigger condition.

The target interface may be an interface of the electronic device to be displayed, such as a call interface of the electronic device.

The first trigger condition may be a condition that indicates that the electronic device needs to use the function of the proximity sensor to perform the required control based on the detection result of the proximity sensor. The first trigger condition may include, but is not limited to, at least one of the following:
a1, receiving a call request from an electronic device other than the electronic device;
a2, initiating a call request to an electronic device other than the electronic device; or
a3, detecting the user's recording playback instruction.

In the embodiments of the present disclosure, the processor may be used to control the proximity sensor to be in the enabled state based on the satisfaction of the first trigger condition, to detect whether a proximity event/proximity behavior of a target object such as a human body occurs through the sensing of the collection area of the proximity sensor, and to perform the required control on the electronic device based on the detection result.

The processor may control the capacitive proximity sensor to be in the enabled state based on the electronic device receiving a call request from another electronic device, or based on the electronic device initiating a call request to another electronic device, or based on detecting the user's recording playback instruction, to detect whether a human body proximity event occurs through the capacitive proximity sensor. The capacitive proximity sensor may provide a conductive plate system formed by one capacitor or a group of capacitors as a sensitive element of the capacitive proximity sensor. When a conductor such as a human body appears or passes nearby, the electrostatic field distribution in the conductive plate system may change, and the capacitance of the sensitive element may change accordingly, such that whether a human body proximity event occurs is able to be detected based on the induction of the collection area and the capacitance change value of the sensitive element based on this. When the capacitance change value reaches a set value, it may be determined that a human body proximity event occurs (for example, the user puts the mobile phone close to the ear to make a call or the user puts the mobile phone close to the ear to listen to the playback recording, etc.), and then, based on the detection result, the electronic device may be controlled to turn off the screen or lock the screen to avoid the phenomenon of muting the call, hanging up, or muting the recording playback because of accidentally touching the screen. It is easy to understand that when the human body proximity event is not detected by the capacitive proximity sensor, it may not be necessary to control the electronic device to turn off the screen or lock the screen.

The second trigger condition may be a condition that indicates that the electronic device may potentially affect the screen operation of the target screen because of the proximity sensor being controlled to be in the enabled state or being in the enabled state. The second trigger condition may include, but is not limited to, any one of the following:
b1, the second trigger condition is the same as the first trigger condition; or
b2, the second trigger condition is that the proximity sensor is in the enabled state.

For b1, the second trigger condition may be the same as the first trigger condition.

In this case, the second trigger condition may be, but is not limited to, at least one of the above conditions a1, a2, or a3. When the processor detects that conditions a1, a2, or a3 are satisfied, it may be determined that the second trigger condition is satisfied, and based on the satisfaction of the second trigger condition, the target interface may be controlled to be displayed in the display area of the target screen in the first display mode.

When any one of conditions a1, a2, or a3 is satisfied, the processor may control the proximity sensor to be in the enabled state. Since the proximity sensor is controlled to be in the enabled state, the electronic device may perform turning off the screen, locking the screen, or other controls because of the proximity sensor detecting the proximity event of a target object such as a human body, which may potentially affect the user's screen operation of the target screen. For example, when the user approaches the electronic device intending to operate the screen interface of the target screen, such as when the user extends his finger to the recording button or number button on the call interface of the electronic device in the hope of clicking on the recording button/number button or other controls to record the call process or further dial an extension number, the proximity sensor may detect a human proximity event if the control to be operated overlaps (completely or partially overlaps) with the collection area of the proximity sensor, and the control of turning off/locking the screen or other operations performed on the target screen based on the detection result of the proximity sensor may affect the user's normal operation of the recording button or number button on the screen interface of the target screen, making it difficult to ensure that the user is able to operate the screen interface without obstacles. In response to this situation, the embodiment of the present disclosure may control the target interface to be displayed in the display area of the target screen in the first display mode to avoid the influence of the proximity sensor being controlled to be in the enabled state on the screen operation of the target screen.

For b2, the second trigger condition may be that the proximity sensor is in the enabled state. When the proximity sensor is in the enabled state, the electronic device may perform turning off the screen, locking the screen, or other controls on the target screen because of the proximity sensor detecting the proximity event of the target object such as a human body. Similar to the case of b1, when the user approaches the electronic device with the intention of operating the screen interface of the target screen, and the control to be operated overlaps (completely or partially overlaps) with the collection area of the proximity sensor, turning off the screen, locking the screen, or other controls performed on the electronic device because of the proximity sensor detecting the human body proximity event may affect the user's normal screen operation on the target screen. For this case of b2, the embodiment of the present embodiments may control the target interface to be displayed in the display area of the target screen in the first display mode to prevent the screen operation of the target screen from being affected by the proximity sensor being controlled to be the enabled state.

When the target interface is displayed in the first display mode, the target control included in the target interface may not overlap with the collection area and may not overlap with the target area. The target area may belong to the display area and may be related to the target edge of the collection area.

The target interface may include the target control. The target control may include, but is not limited to, control buttons (such as mute, hands-free, recording, etc. buttons), numeric keys (such as various numeric keys in a dialing keypad), or any one or more types of controls.

The distance between the collection area and a first edge of the display area (i.e., the display area of the target screen) may be less than the distance between the collection area and a second edge of the display area, and an edge of the collection area corresponding to the first edge of the display area may be the target edge.

The first edge and the second edge may be two opposite edges of the display area of the target screen, respectively.

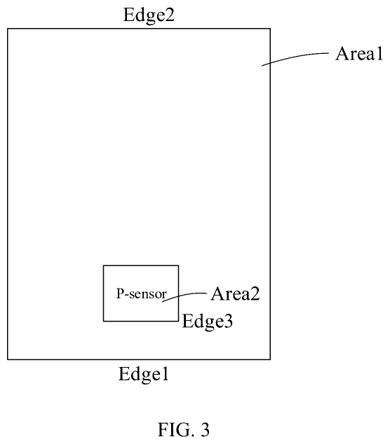

As shown in FIG. 3, Area1 represents the display area of the target screen, Area2, i.e., the P-sensor area in FIG. 3, represents the collection area of the proximity sensor. Edge1 of Area1 is the first edge, and Edge2 is the second edge. In this example, Edge1 and Edge2 are specifically the lower edge and the upper edge of the display area of the target screen, respectively. The distance between the collection area Area2 and the first edge Edge1 of the display area Area1 is less than the distance between the collection area Area2 and the second edge Edge2 of the display area Area1.

The edge corresponding to the first edge Edge1 of the collection area Area2 and the display area Area1, such as Edge3 in the figure, is the target edge of the collection area Area2. The target edge of the collection area Area2 may be a point or an edge, depending on the shape of the collection area Area2, and there is no limitation on this. For example, in FIG. 3, the shape of Area2 is a matrix, and its target edge Edge3 is an edge. In some other embodiments, the shape of Area2 may be an inverted triangle, a cone, etc., and then its target edge may be a point.

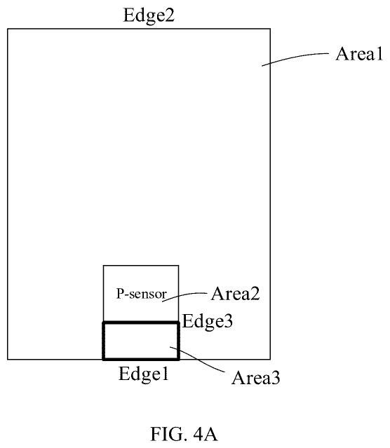

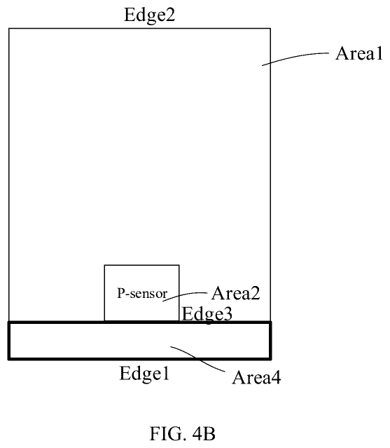

The target area may belong to the display area and may be related to the target edge of the collection area. Optionally, the target area may be an area between the target edge of the collection area (or the horizontal line where the target edge is located in the display area) and the first edge of the display area in the display area, for example, Area 3 in FIG. 4A or Area 4 in FIG. 4B.

When the second trigger condition is satisfied, the processor may control the target interface to be displayed in the display area of the target screen in the first display mode, such that the target control included in the target interface is displayed in the display area of the target screen to avoid the collection area and the target area. Therefore, when the user operates the target control of the target interface by extending a finger or the like, the target control of the target interface may be laid out and displayed to avoid the collection area and the target area, and may not overlap with the collection area and the target area. Therefore, it may not be sensed by the collection area of the proximity sensor and detected as a human proximity event, and the target screen of the electronic device may not be controlled to turn off or lock the screen accordingly, such that the screen operation of the target screen may not be affected by the proximity sensor being controlled to be enabled or in the enabled state. While being able to perform the required control based on the proximity event sensing capability of the proximity sensor to prevent accidental touches on the target screen (for example, when the mobile phone is placed close to the ear for a call, the mobile phone screen may be controlled to turn off/lock the screen based on the proximity sensor to detect a human proximity event to prevent accidental touches), and it may also be ensured that the user is able to perform the operation on the display interface of the target screen without obstacles.

In the electronic device provided by the present disclosure, by controlling the proximity sensor to be in the enabled state based on the satisfaction of the first trigger condition, the proximity event detection capability of the target object such as the human body provided by the proximity sensor may be implemented, to perform the required control on the target screen of the electronic device to prevent accidental touching of the target screen. And, by controlling the target interface to be displayed in the display area of the target screen in the first display mode based on the satisfaction of the second trigger condition, it may be achieved that, when the proximity sensor is controlled to be enabled or is in the enabled state, the target control included in the target interface may be laid out and displayed on the display area of the target screen to avoid the collection area and the target area, such that the screen operation of the target screen is not affected by the proximity sensor being controlled to be enabled or being in the enabled state. While being able to perform the required control to prevent accidental touching based on the proximity event sensing capability of the proximity sensor, it may also be ensured that the user is able to perform the operation on the target screen display interface without obstacles.

In an optional embodiment, controlling the target interface to be displayed in the display area of the target screen in the first display mode may include: rotating the target interface in the display area of the target screen by a set angle, and making the target control included in the target interface after rotation not overlap with the collection area and the target area.

The rotation angle may be, but is not limited to, 180°.

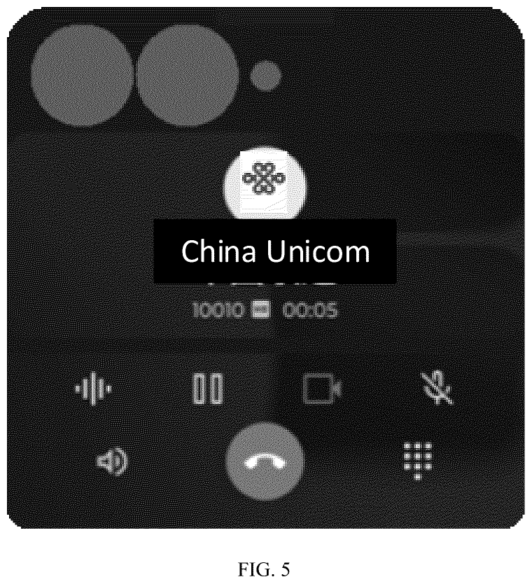

FIG. 5 is a schematic diagram of a call interface obtained by rotating the call interface in FIG. 1 by 180°. In the call interface after rotation by 180°, the control does not overlap with the collection area and the target area. The user is able to operate the required control (such as hang up button or a hands-free button) on the interface normally and unimpededly according to the needs, and the target screen where the call interface is located may not be turned off or locked because of the proximity sensor misidentifying the user operation as a human body proximity event.

Optionally, after the target interface is rotated by a set angle in the display area of the target screen, a prompt message may also be output to prompt the user to use the electronic device based on the correct device attitude. For example, after the target interface is rotated 180° in the display area of the target screen of the mobile phone to realize the display of the target interface in the first display mode, the user may be prompted by text and/or voice prompts such as “please rotate 180° to use the mobile phone.”

In actual applications, controlling the target interface to be displayed in the display area of the target screen in the first display mode, is not limited to the above-mentioned implementation method of rotating the target interface in the display area of the target screen by a certain angle. In other embodiments, the various target controls included in the target interface may be rearranged and displayed, and the various target controls after the rearrangement and display may not overlap with the collection area and the target area. As long as it is able to be ensured that the various target controls of the displayed target interface do not overlap with the collection area and the target area, they all belong to the protection scope of the first display mode in the embodiment of the present disclosure.

In the embodiments of the present disclosure, when the target interface is controlled to be displayed in the first display mode, in addition to requiring that the target controls included in the target interface do not overlap with the collection area, the target controls may also not overlap with the target area, mainly based on the following considerations.

On the one hand, considering that the target area and the collection area are adjacent areas, when the target controls included in the target interface overlap with the target area, it may be easy to cause an accidental touch on the collection area because the target area is close to the collection area when operating the target controls in the target area, which may easily lead to the detection of the user's operation on the target controls as a human body proximity behavior and the corresponding erroneous control of turning off/locking the target screen.

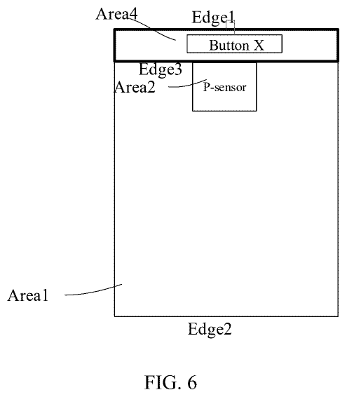

On the other hand, when the target controls included in the target interface overlap with the target area, the user's finger/arm or other operating body may need to cross the collection area of the proximity sensor to operate the target controls in the target area. For example, as shown in FIG. 6, when the target interface is displayed in the first display mode by rotating the target interface 180°, the user's finger needs to cross the collection area of the P-sensor area in the figure to operate the button X in the target area. In this case, it is also easy to detect the user's operation on the target control as a human body proximity behavior, and cause the target screen to turn off/lock the screen.

In the embodiments of the present disclosure, when the target interface is controlled to be displayed in the first display mode by rotating the target interface, in addition to requiring that the target controls included in the target interface do not overlap with the collection area, it may also require that the target controls do not overlap with the target area, which effectively solves the above two problems, avoids the target screen from being mis-controlled because of the mis-touch in the collection area, or the operation of the controls by the user's finger/arm or other operating body crossing/crossing the collection area, thereby ensuring that the user is able to perform the operation on the target screen display interface without obstacles.

In an optional embodiment, the processor of the electronic device may also be used to control the display in a second display mode before the second trigger condition is met.

The first display mode may be different from the second display mode, and the second display mode may correspond to the proximity sensor being in a disabled state.

Optionally, the second display mode may be a default display mode of the display interface on the target screen of the electronic device, and the default display mode may also be understood as a conventional display mode of the display interface.

When the proximity sensor is in the disabled state, the electronic device may not detect the proximity behavior of the target object such as the human body based on the proximity sensor and may not perform the related control based on this. In this case, the display interface to be displayed on the target screen may be displayed in its default display mode, that is, the second display mode. For example, the current video viewing interface may be directly displayed on the outer screen of the foldable mobile phone shown in FIG. 1 in the default display mode. Since the under-screen proximity sensor is located at the bottom of the outer screen of the foldable mobile phone rather than the top of the outer screen in FIG. 1, the controls on the display interface may (usually) overlap with the collection area and/or the target area of the proximity sensor. However, at this time, since the proximity sensor is in the disabled state, even when the controls on the display interface overlap with the collection area and/or the target area of the proximity sensor, the user operation may not be misidentified as a human proximity behavior resulting in erroneous control of the display screen such as the outer screen of the foldable mobile phone including turning off the screen/locking the screen when the user operates the controls on the display interface.

In an optional embodiment, the electronic device may further include a first body and a second body.

The first body may include the proximity sensor, that is, the proximity sensor may be arranged on the first body. Further, the target screen of the electronic device may also be disposed on the first body.

Optionally, for example, the proximity sensor may be arranged under the screen of the target screen on the first body to form an under-screen proximity sensor of the target screen, and the distance between the collection area of the proximity sensor and the first edge of the display area of the target screen may be less than the distance between the collection area and the second edge of the display area. Accordingly, the proximity sensor may be disposed under the screen of the target screen close to the first edge of the display area of the target screen.

The second body may be disposed on the electronic device and opposite to the first body.

The first body and the second body may be stacked (folded) or unfolded with each other, and the electronic device may be correspondingly a foldable device, such as a foldable mobile phone.

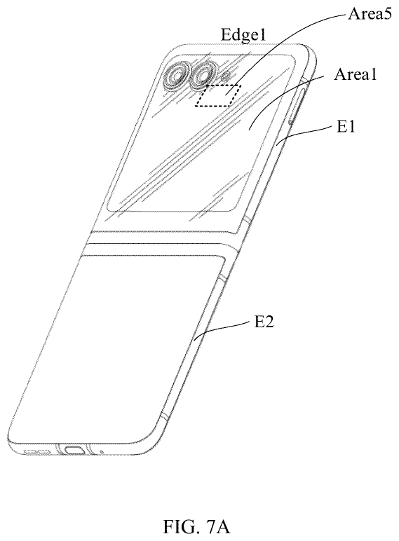

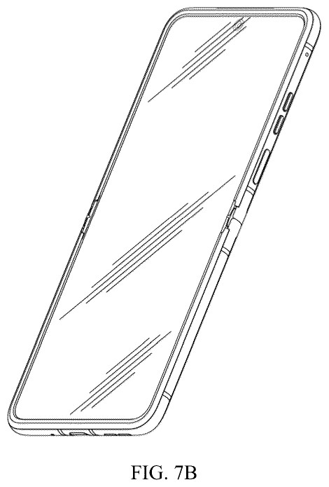

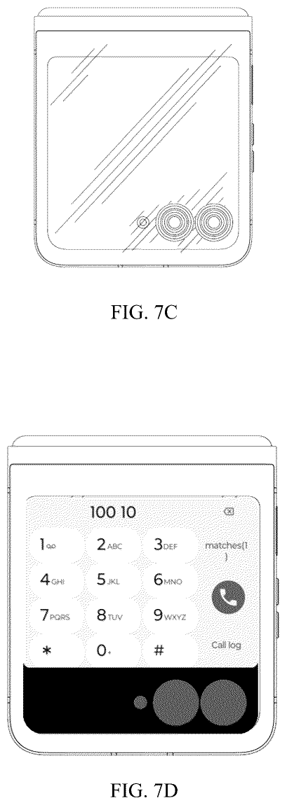

As shown in the example of a foldable mobile phone in FIG. 7A, Area1 represents the display area of the target screen of the foldable mobile phone, Body E1 where Area1 is located is the first body of the foldable mobile phone, and Body E2 arranged opposite to the first body E1 is the second body of the foldable mobile phone. The two bodies may be stacked (folded) or unfolded. FIG. 7A shows the shape of the two bodies after unfolding, that is, the shape in the perspective of the outer screen after the inner-screen foldable mobile phone is unfolded. FIG. 7B shows the shape of the other side of the two bodies opposite to FIG. 7A after unfolding, that is, the shape in the perspective of the inner screen. FIG. 7C shows the shape of the two bodies when they are stacked on each other. The proximity sensor is provided on the first body E1, and is provided in the area under the screen of the target screen close to the first edge Edge1 of the target screen display area Area1, such as the area Area5 indicated by the dotted lines in FIG. 7A (Area5 is drawn with dotted lines to indicate that the area is the under-screen area of the target screen, and the user cannot see the area on the target screen). It is easy to understand that the collection area of the proximity sensor is the area on Area1 corresponding to Area5, which may be the projection area of Area5 projected onto Area1, or it may also be an area related to the projection area, such as an area on Area1 that includes at least part of the projection area, etc., depending on the actual situation.

The second body and the first body may be different bodies independent of each other of the electronic device, such as two bodies of a folding mobile phone that are connected by a connection shaft or hinge and may be folded/unfolded with each other, but are not limited to this. The second body and the first body may also be different parts of the same body of the electronic device, such as two parts on a flexible device that are able to be folded/unfolded with each other based on the flexible material of the flexible device.

In this embodiment, the processor may be used to: when a target parameter indicates that the first body and the second body are in a target attitude, control the display in the second display mode.

The first display mode may be different from the second display mode.

The target attitude may be that the first body and the second body are stacked, and the display area to which the collection area of the proximity sensor belongs may be an appearance surface of the electronic device. The distance between the collection area and the first edge of the display area may be less than the distance between the collection area and the second edge of the display area, and the target edge may be an edge of the collection area that corresponds to the first edge of the display area.

The target parameter may include but is not limited to the angle between the first body and the second body, and/or the distance between the preset positions of the first body and the second body. The preset positions of the first body or the second body may be but is not limited to the geometric center point of the first body or the second body.

Taking the electronic device being a foldable mobile phone as an example, the target parameter may include but is not limited to the angle between the dual screens of the foldable mobile phone (the two screens in the dual screen may be located in the first body and the second body respectively), and/or the distance between the geometric centers of the dual screens.

In one embodiment, when it is detected that the angle between the first body and the second body is less than a set angle and/or the distance between the preset positions of the first body and the second body is less than a set distance, it may be determined that the target parameter indicates that the first body and the second body are in the target attitude (i.e., the first body and the second body are stacked).

Optionally, in one embodiment, when the target parameter indicates that the first body and the second body are in the target attitude, controlling the display in the second display mode, may include: when the target parameter indicates that the first body and the second body are in a stacked state (folded state), displaying the interface to be displayed, such as the target interface, in its default display mode on the target screen set on the first body. For example, for the folding mobile phone in the folded state in FIG. 7C, the dialing interface is displayed in its default display mode on the target screen, and the display effect may be seen in the schematic diagram of FIG. 7D. Since the display area of the target screen is the appearance surface of the electronic device, when the first body and the second body of the electronic device are in the stacked state, the display may be controlled in the second display mode, and the target interface waiting for display may be displayed on the target screen, which may ensure that the user is able to watch the displayed content normally. Further, in this embodiment, the proximity sensor may be in the disabled state, and the controls on the interface displayed in the default display mode may overlap with the collection area of the proximity sensor and/or the target area. Since the proximity sensor is in the disabled state, even when the displayed controls overlap with the collection area and/or the target area, the user's operation of the controls may not be mistakenly detected as a human proximity behavior causing the target screen to be turned off/locked, etc., thereby ensuring the user's barrier-free operation of the target screen display interface.

Taking the electronic device being a foldable device including a dual screen (such as a foldable mobile phone) as an example, when the electronic device is an inner-screen foldable device, the target screen may be the outer screen of the electronic device, such as the screen where Area1 is located in FIG. 7A, the first body may be the body where the outer screen is located in the two bodies (such as two bodies connected by a hinge) included in the electronic device, such as E1 in FIG. 7A, and the second body may be another body other than the body where the outer screen is located, such as E2 in FIG. 7A. For an inner-screen foldable device, when the target parameter represents that the first body and the second body of the device are stacked (that is, the inner-screen foldable device is in a folded state), the processor may control the interface to be displayed on the outer screen of the device to ensure that the user is still able to view the display content on the device interface normally when the inner-screen foldable device is in the folded state. Also, since the proximity sensor is in the disabled state, the user's unimpeded operation of the displayed controls may be ensured.

In one embodiment, when the electronic device is an outer screen foldable device, the target screen may be a side with the proximity sensor on one of the two sides of the overall screen of the electronic device that is able to be folded or unfolded by folding the outer screen. In this embodiment, this side is referred to as the first side. The first body may be one body where the first side is located, and the second body may be one body where a second side other than the first side is located. For the outer screen foldable device, when the target parameter characterizes that the first body and the second body of the device are stacked (that is, the outer screen foldable device is in the folded state), the processor may control the interface waiting for display to be displayed on the side with the proximity sensor to which the overall screen of the device is reduced after the device is in the outer screen folded state, that is, to be displayed on the first side. It is easy to understand that for the outer screen foldable device, the first side may be obviously on the appearance surface of the device, such that the user is able to also watch the displayed content on the device interface normally. Since the proximity sensor is in the disabled state, it may also be ensured that the user is able to operate the displayed controls without obstacles.

In an optional embodiment, when the target parameter indicates that the first body and the second body are in the target attitude and the second trigger condition is satisfied, the processor may control the target interface to be displayed in the display area of the target screen in the first display mode.

Optionally, as described above, the target attitude may be the stacking of the first body and the second body, which may be understood as the folded state of the electronic device. When it is detected that the angle between the first body and the second body is less than the set angle and/or the distance between the preset positions (such as the geometric center) of the first body and the second body is less than the set distance, it may be determined that the target parameter indicates that the first body and the second body are in the target attitude (i.e., the folded state of the first body and the second body stacked).

Referring to the description of the second trigger condition above, when the second trigger condition is satisfied, the proximity sensor may be controlled to be enabled, or already in the enabled state.

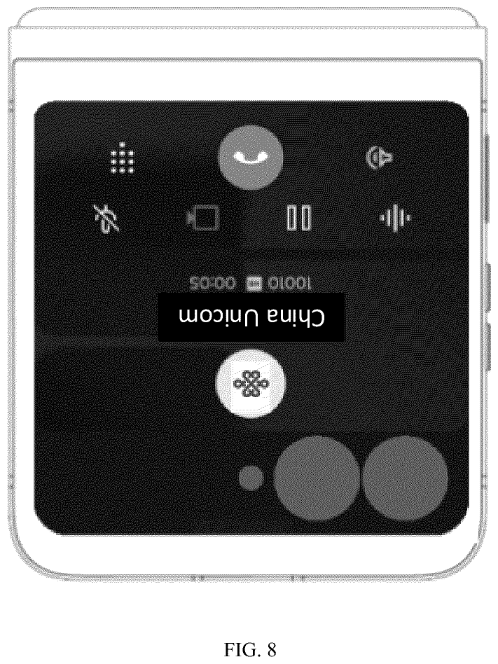

For the electronic device, which is a foldable device (such as a foldable mobile phone) including the first body and the second body, when the target parameter indicates that the first body and the second body are in the target attitude and the second trigger condition is satisfied, the processor may control the target interface to be displayed in the display area of the target screen in the first display mode. As shown in FIG. 8, the target interface is controlled to be displayed in the first display mode on the outer screen of the inner-screen foldable mobile phone. On the one hand, for the electronic device in the target attitude (the folded state), the target interface may be displayed on the appearance surface of the electronic device to ensure that the user is able to view the displayed content normally. On the other hand, the target controls included in the target interface may not overlap with the collection area of the proximity sensor and the target area, to ensure that the user's operation on the target controls may not be mistakenly recognized by the proximity sensor as a human proximity behavior resulting in erroneous control of the target screen such as turning off the screen/locking the screen. Therefore, the user's barrier-free operation on the target screen display interface may be ensured.

For a foldable device such as an inner-screen foldable device or an outer-screen foldable device (such as an inner-screen foldable or outer-screen foldable mobile phone), when the dual screens of the foldable device are in an unfolded state to form an integral large screen, the proximity sensor provided by the foldable device may be usually located above (at the top of) the large screen, as shown in FIG. 7A. Therefore, in this state, for application scenarios such as calls, the proximity sensor may effectively sense the human body proximity behavior and then perform the required control of the device such as turning off the screen/locking the screen. However, for this setting method of the proximity sensor, when the dual screens of the foldable device are in the target attitude (the first body and the second body are stacked), the proximity sensor may be located below (at the bottom of) the corresponding screen (that is, the target screen of the electronic device, such as the outer screen of the foldable mobile phone), as shown in FIG. 7C. For the position of the proximity sensor, the controls in the display area of the target screen may usually overlap with the collection area of the proximity sensor. When the proximity sensor is controlled to be in the enabled state or is already in the enabled state, if the user needs to operate the displayed controls, as shown in the example of FIG. 7D and the user extends a finger to touch the collection area, it may be sensed by the proximity sensor as a human body proximity event, which may result in erroneous control of the target screen such as turning off/locking the screen, thereby affecting the user's normal operation of the displayed controls and making it difficult to ensure that the user is able to operate the screen without obstacles.

In this embodiment, the above problem may be effectively alleviated by controlling the target interface to be displayed in the display area of the target screen in the first display mode (as shown in the example of FIG. 8) when the target parameter indicates that the first body and the second body are in the target attitude and the second trigger condition is met. While being able to perform the required control based on the proximity behavior sensing capability of the proximity sensor to prevent false touches, it may also be ensured that the user is able to operate the target screen display interface without obstacles.

It should be noted that the method provided in the embodiments of the present disclosure is not limited to application to foldable devices such as foldable phones. Any device equipped with an under-screen proximity sensor may adopt the method provided in the embodiments of the present disclosure to achieve the effect of not only performing the required control based on the proximity behavior sensing capability of the proximity sensor to prevent accidental touches, but also ensuring that the user is able to perform the operation on the target screen display interface without obstacles.

In an optional embodiment, the processor in the electronic device may also be used to control the display of a first display interface in the second display mode.

In this embodiment, when the second trigger condition is satisfied, the processor may control the display of the second display interface in the first display mode. The second display interface may be the target interface, and the first display interface and the second display interface may belong to the same application.

The direction of the first display interface displayed in the second display mode may be opposite to the direction of the second display interface displayed in the first display mode.

The processor may control the display of the first display interface in the second display mode when the second trigger condition is not satisfied. When the second trigger condition is not satisfied, the controller may control the display of the first display interface in the display area of the target screen in the second display mode. For example, assuming that the second trigger condition is that the proximity sensor is in the enabled state and the second display mode is the default display mode of the first display interface, the processor may control the display of the first display interface in the display area of the target screen in the corresponding default display mode when the proximity sensor is in the disabled state. In the default display mode, the controls of the first display interface may overlap with the collection area of the proximity sensor and/or the target area. Since the proximity sensor is in the disabled state at this time, even if the controls of the first display interface overlap with the collection area of the proximity sensor and/or the target area, when the user operates the controls on the display interface, the user operation may not be misidentified as a human body proximity behavior resulting in erroneous control of the target screen such as turning off the screen/locking the screen.

When the second trigger condition is satisfied, the processor may control the display of the second display interface in the first display mode, and control the display of the second display interface in the first display mode, such that the target controls included in the second display interface do not overlap with the collection area of the proximity sensor and the target area, thereby avoiding the influence on the screen operation of the target screen because of the proximity sensor being in the enabled state.

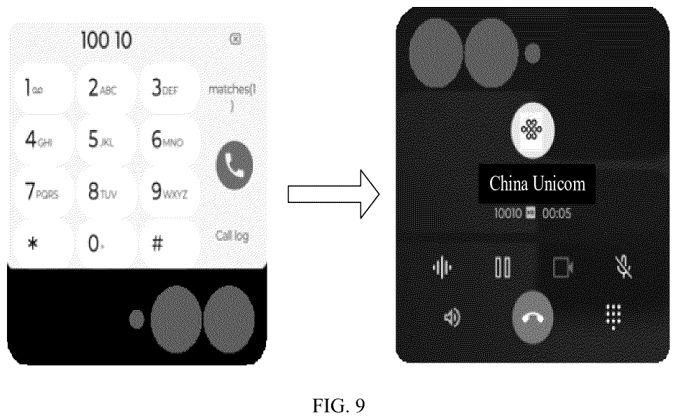

For example, when the user needs to make an outgoing call and the user inputs the number by operating the numeric keys to dial, the processor may control the display of the dialing interface in the second display mode, such as the dialing interface in FIG. 9. When the number input is completed and the outgoing call request is made, the first trigger condition may be satisfied, and the proximity sensor may be controlled to be in the enabled state based on the satisfaction of the first trigger condition, which may correspondingly cause the second trigger condition to be satisfied (assuming that the second trigger condition is that the proximity sensor is in the enabled state). The controller then may automatically control the display interface to rotate 180° based on the satisfaction of the second trigger condition, and accordingly display the next display interface in the first display mode, such as the call interface shown in FIG. 9. In this example, the dialing interface is the first display interface, and the call interface is the second display interface, that is, the target interface. The direction of the dialing interface displayed in the second display mode is opposite to the direction of the call interface displayed in the first display mode.

Optionally, when the display interface is rotated 180° such that the second display interface is displayed in the first display mode, a prompt message may also be output to remind the user to use the electronic device in a more reasonable device attitude (for the example of FIG. 8, reminding the user to rotate the mobile phone) 180°. And, for application scenarios such as calls, since the handset is usually set at the bottom of the outer screen of the device, it may be placed next to the ear after rotating 180° to make the call sound clearer and may not cause a decrease in call quality.

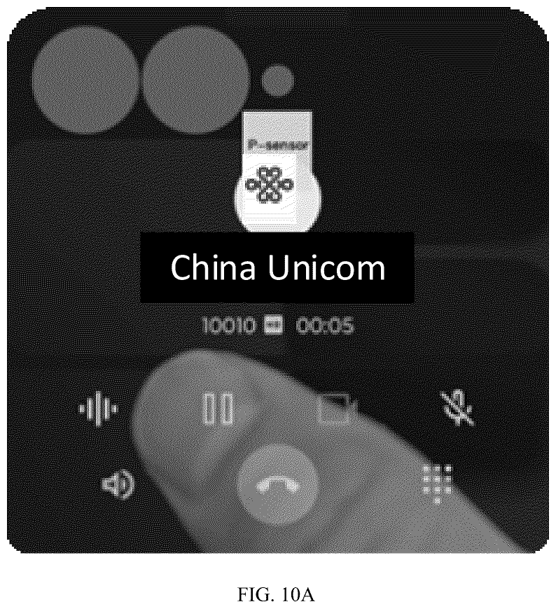

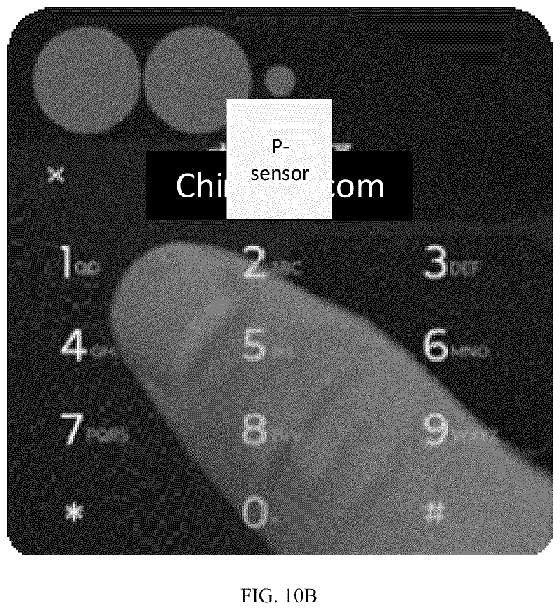

Based on this embodiment, it may be achieved that while the required control can be performed based on the proximity behavior sensing capability of the proximity sensor to prevent accidental touches on the target screen, the user may also be guaranteed to have obstacle-free operation on the target screen display interface, as shown in FIG. 10A and FIG. 10B respectively.

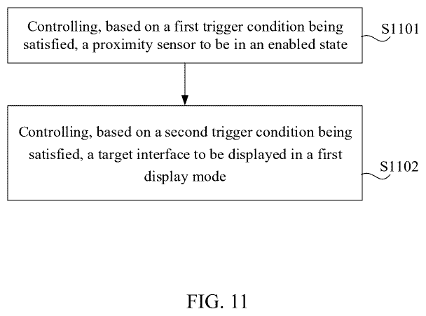

The present disclosure also provides a control method. As shown in FIG. 11, in one embodiment, the control method includes:
S1101, based on the first trigger condition being satisfied, controlling the proximity sensor to be in the enabled state; and
S1102, based on the second trigger condition being satisfied, controlling the target interface to be displayed in the first display mode.

The target interface may be displayed in the first display mode, such that the target controls included in the target interface do not overlap with the collection area of the proximity sensor and do not overlap with the target area. The collection area may correspond to the display area of the target screen. The target area may belong to the display area and may be related to the target edge of the collection area.

In an optional embodiment, the control method may further includes:
displaying the first display interface in the second display mode.

Based on the satisfaction of the second trigger condition, controlling the target interface to be displayed in the first display mode may include:
when the second trigger condition is satisfied, displaying the second display interface in the first display mode.

The second display interface may be the target interface. The first display interface and the second display interface may belong to the same application. The direction of the first display interface displayed in the second display mode may be opposite to the direction of the second display interface displayed in the first display mode.

In an optional embodiment, the control method, before the second trigger condition is satisfied, may further include:
when the target parameter indicates the target attitude, controlling the display in the second display mode.

The first display mode may be different from the second display mode.

The target attitude may be the stacking of the first body and the second body of the electronic device. The display area to which the collection area of the proximity sensor belongs may be the appearance surface of the electronic device. The distance between the collection area and the first edge of the display area may be less than the distance between the collection area and the second edge of the display area, and the target edge may be an edge of the collection area that corresponds to the first edge of the display area.

In an optional embodiment, based on the satisfaction of the second trigger condition, controlling the target interface to be displayed in the first display mode may include:
when the target parameter indicates the target attitude and the second trigger condition is satisfied, controlling the target interface to be displayed in the first display mode.

For the control method provided in the embodiments of the present disclosure, since it corresponds to the electronic device provided in the above embodiments, the description is relatively simple, and the relevant similarities may be found in the description of the electronic device embodiments above, which will not be described in detail here.

Each embodiment in this specification is described in a progressive manner, and each embodiment focuses on the differences from other embodiments. Same and similar parts between the embodiments can be referred to each other.

For the convenience of description, the above system or device is described by function and is divided into various modules or units. Of course, when implementing the present disclosure, the functions of each unit may be implemented in the same or one or more software and/or hardware.

It can be seen from the description of the above implementation modes that those skilled in the art can clearly understand that the present disclosure may be implemented by means of software plus a necessary general hardware platform. Based on this understanding, the technical solution of the present disclosure that has essential or creative contribution may be implemented in the form of a software product, which may be stored in a storage medium such as ROM/RAM, a magnetic disk, an optical disk, etc. The computer program product may include several instructions to enable a computer device (which may be a personal computer, a server, or a network device, etc.) to execute the methods described in each embodiment of the present disclosure or some parts of the embodiments.

It should be noted that in this article, relational terms such as first, second, third and fourth are used to distinguish one entity or operation from another entity or operation, and do not necessarily require or imply any such actual relationship or order between these entities or operations. Moreover, the terms such as “comprises” “includes,” or any other variation thereof are intended to encompass non-exclusive inclusion, such that a process, method, article, or apparatus that includes a list of elements includes not only those elements but also other elements not explicitly listed, or elements inherent to such process, method, article, or apparatus. In the absence of further limitations, an element defined by the phrase “comprising a . . . ” does not exclude the presence of additional identical elements in the process, method, article, or apparatus that includes the element.

The above are only some embodiments of the present disclosure. It should be noted that for those of ordinary skill in the art, improvements and modifications can be made without departing from the principles of the present disclosure, and these improvements and modifications should also be regarded as being within the scope of the present disclosure.

What is claimed is:

1. An electronic device comprising:
a proximity sensor;
a target screen including a display area, the display area including a collection area corresponding to the proximity sensor; and
a processor configured to:
control, in response to a first trigger condition being satisfied, the proximity sensor to be in an enabled state; and
control, in response to a second trigger condition being satisfied, a target interface to be displayed in the display area in a display mode, in which a target control in the target interface does not overlap with the collection area and does not overlap with a target area, the target area belonging to the display area and being related to a target edge of the collection area.

2. The electronic device according to claim 1, wherein:
the second trigger condition is same as the first trigger condition; or
the second trigger condition is that the proximity sensor is in the enabled state.

3. The electronic device according to claim 1, wherein:
the display mode is a first display mode; and
the processor is further configured to control display in a second display mode before the second trigger condition is satisfied, the second display mode being different from the first display mode and corresponding to the proximity sensor being in a disabled state.

4. The electronic device according to claim 1, further comprising:
a first body including the proximity sensor; and
a second body arranged opposite to the first body;
wherein:
the display mode is a first display mode; and
the processor is further configured to control display in a second display mode in response to a target parameter indicating that the first body and the second body are in a target attitude, the first display mode being different from the second display mode.

5. The electronic device according to claim 4, wherein at the target attitude:
the first body and the second body are stacked;
the display area is an appearance surface of the electronic device; and
a distance between the collection area and a first edge of the display area is less than a distance between the collection area and a second edge of the display area, the target edge of the collection area corresponds to the first edge of the display area.

6. The electronic device according to claim 1, further comprising:
a first body including the proximity sensor; and
a second body arranged opposite to the first body;
wherein the processor is configured to control the target interface to be displayed in the display area in the display mode in response to a target parameter indicating that the first body and the second body are in a target attitude and the second trigger condition being satisfied.

7. The electronic device according to claim 1, wherein:
the display mode is a first display mode; and
the processor is further configured to:
control a first display interface to be displayed in a second display mode; and
control a second display interface to be displayed in the first display mode in response to the second trigger condition being satisfied, the second display interface being the target interface, the first display interface and the second display interface belonging to a same application, and a direction of the first display interface in the second display mode being opposite to a direction of the second display interface in the first display mode.

8. A control method comprising:
controlling, in response to a first trigger condition being satisfied, a proximity sensor to be in an enabled state, the proximity sensor corresponding to a collection area in a display area of a target screen of an electronic device; and
controlling, in response to a second trigger condition being satisfied, a target interface to be displayed in a display mode, in which a target control in the target interface does not overlap with the collection area and does not overlap with a target area, the target area belonging to the display area and being related to a target edge of the collection area.

9. The control method according to claim 8, wherein:
the second trigger condition is same as the first trigger condition; or
the second trigger condition is that the proximity sensor is in the enabled state.

10. The control method according to claim 8,
wherein the display mode is a first display mode;
the method further comprising:
controlling display in a second display mode before the second trigger condition is satisfied, the second display mode being different from the first display mode and corresponding to the proximity sensor being in a disabled state.

11. The control method according to claim 8,
wherein:
the electronic device further includes:
a first body including the proximity sensor; and
a second body arranged opposite to the first body; and
the display mode is a first display mode;
the method further comprising:
controlling display in a second display mode in response to a target parameter indicating that the first body and the second body are in a target attitude, the first display mode being different from the second display mode.

12. The control method according to claim 11, wherein at the target attitude:
the first body and the second body are stacked;
the display area is an appearance surface of the electronic device; and
a distance between the collection area and a first edge of the display area is less than a distance between the collection area and a second edge of the display area, the target edge of the collection area corresponds to the first edge of the display area.

13. The control method according to claim 8,
wherein:
the electronic device further includes:
a first body including the proximity sensor; and
a second body arranged opposite to the first body; and
the display mode is a first display mode;
the method further comprising:
controlling the target interface to be displayed in the display area in the display mode in response to a target parameter indicating that the first body and the second body are in a target attitude and the second trigger condition being satisfied.

14. The control method according to claim 8,
wherein the display mode is a first display mode; and
the method further comprising:
controlling a first display interface to be displayed in a second display mode; and
controlling a second display interface to be displayed in the first display mode in response to the second trigger condition being satisfied, the second display interface being the target interface, the first display interface and the second display interface belonging to a same application, and a direction of the first display interface in the second display mode being opposite to a direction of the second display interface in the first display mode.

15. A non-transitory computer-readable storage medium storing instructions that, when executed by a processor, cause the processor to:
control, in response to a first trigger condition being satisfied, a proximity sensor to be in an enabled state, the proximity sensor corresponding to a collection area in a display area of a target screen of an electronic device; and
control, in response to a second trigger condition being satisfied, a target interface to be displayed in a display mode, in which a target control in the target interface does not overlap with the collection area and does not overlap with a target area, the target area belonging to the display area and being related to a target edge of the collection area.

16. The storage medium according to claim 15, wherein:
the second trigger condition is same as the first trigger condition; or
the second trigger condition is that the proximity sensor is in the enabled state.

17. The storage medium according to claim 15, wherein:
the display mode is a first display mode; and
the instructions, when executed by the processor, further cause the processor to control display in a second display mode before the second trigger condition is satisfied, the second display mode being different from the first display mode and corresponding to the proximity sensor being in a disabled state.

18. The storage medium according to claim 15, wherein:
the electronic device further includes:
a first body including the proximity sensor; and
a second body arranged opposite to the first body;
the display mode is a first display mode; and
the instructions, when executed by the processor, further cause the processor to control display in a second display mode in response to a target parameter indicating that the first body and the second body are in a target attitude, the first display mode being different from the second display mode.

19. The storage medium according to claim 18, wherein at the target attitude:
the first body and the second body are stacked;
the display area is an appearance surface of the electronic device; and
a distance between the collection area and a first edge of the display area is less than a distance between the collection area and a second edge of the display area, the target edge of the collection area corresponds to the first edge of the display area.

20. The storage medium according to claim 15, wherein:
the electronic device further includes:
a first body including the proximity sensor; and
a second body arranged opposite to the first body;
the display mode is a first display mode; and
the instructions, when executed by the processor, further cause the processor to control the target interface to be displayed in the display area in the display mode in response to a target parameter indicating that the first body and the second body are in a target attitude and the second trigger condition being satisfied.
